(19) United States
(12) Patent Application Publication
(10) Pub. No.: US 2026/0147559 A1
(43) Pub. Date: May 28, 2026

(54) DISTRIBUTING SOFTWARE UPDATES FOR SMART CARTS ON DEDICATED NETWORK OF CHARGING STATION

(71) Applicant: Maplebear Inc., San Francisco, CA (US)

(72) Inventors: Benjamin David Bader, Boulder, CO (US); Kaushik Gopal, Oakland, CA (US)

(21) Appl. No.: 18/962,334

(22) Filed: Nov. 27, 2024

(51) Int. Cl. G06F 8/65; H04L 67/00; H04L 67/12

(52) U.S. Cl. CPC G06F 8/65; H04L 67/12; H04L 67/34

(57) ABSTRACT

A method for selecting a smart shopping cart for update through a series of first and second networks. A method for receiving, at a charging station, a cart update from a remote server through a first network, wherein the cart update is an update to software operating on a set of smart shopping carts. The method receives cart data from the set of smart shopping carts through a second network, wherein the cart data is data describing the set of smart shopping carts, wherein the second network comprises the charging station and the set of smart shopping carts. The method proposed computes an update score for each of the set of smart shopping carts based on the cart data and a set of cart selection parameters. The method selects and transmits an update based on the computed update score.

### BACKGROUND

Smart shopping carts include on-board computing devices that execute software for performing the functionalities of those carts. For example, the on-board computing devices may have operating systems that manage the resources of the smart shopping cart, firmware for the sensors and other devices of the smart shopping cart, and a client application for self-checkout functionalities and for presenting content to a user of the cart. New versions of this software are developed by engineers of these carts and are distributed to the smart shopping carts. These cart updates can improve the functionality of the smart shopping carts by, for example, adding new features to the smart shopping cart, increasing the performance of the onboard computing device, or addressing security or privacy issues with the software.

Traditionally, software updates can be distributed to Internet-connected devices by simply transmitting the software update via the Internet to each device that needs to be updated. However, the environments in which smart shopping carts are typically deployed make this approach technically infeasible. Specifically, smart shopping carts are typically deployed in areas whose local networks are limited or non-existent. Thus, individually distributing a software update to each of the smart shopping carts can use more network resources than are available at the local network. Furthermore, even traditional local networks in other contexts may be overtaxed by the amount of bandwidth required to transmit software updates to each of the smart shopping devices.

### SUMMARY

To address these issues, a charging station stores software updates for smart shopping carts from a remote system and distributes those updates over a separate station network from the network used to download the updates. The charging station is connected to an external network and receives cart updates from a remote system via that external network. That external network may include a local network of the environment in which the charging station is operating and may include a wider network, such as the Internet. The charging station stores the received cart updates and distributes the cart updates to smart shopping carts through a station network. This station network may be a local wireless network, such as a separate local network from the one connected to the external network or a Bluetooth connection, or a physical network through which the smart shopping carts are connected to the charging station. In some embodiments, the station network includes a physical connection through a charging port used by smart charging carts for charging and the cart updates are transmitted to smart shopping carts while the carts are charging.

The charging station may selectively distribute cart updates to smart shopping carts based on collected cart data from the carts. The charging station may compute, for each cart, an update score that represents a priority of transmitting the update to that cart. For example, the update score may prioritize updating smart shopping carts during times of day when the smart shopping carts are not in high demand or when the smart shopping carts are deeper within a stack of carts. Similarly, the update score may deprioritize updating smart shopping carts when those carts have low battery.

The charging station may also stage cart data for transmission to the remote system. For example, the charging station may filter out cart data that the remote system is not needed for the remote system or may remove private or sensitive information that may be captured in the cart data. In some embodiments, the charging station generates feature sets of cart data and transmits the feature sets to the remote system. For example, the charging station may apply an embedding model to image data or video data captured by the smart shopping carts and transmit the generated embeddings to the remote system.

By using the charging station as an intermediary storage and distribution system for cart updates, the charging station provides an improvement to the technical field of the distribution of software updates. Specifically, the charging station performs a single download of a cart update and handles the distribution of the cart update on a separate network from the one that may be used by other devices in the charging station's environment. Thus, the charging station reduces the bandwidth needed in the limited local network in the station's environment through the use of the separate station network.

### BRIEF DESCRIPTION OF DRAWINGS

FIG. 1 illustrates an example environment of a smart cart system, in accordance with one or more illustrative embodiments.

FIG. 2 illustrates a flowchart of a cart charging system, in accordance with one or more illustrative embodiments.

FIG. 3 illustrates the distribution of the cart update and the cart data in the smart cart system, in accordance with one or more illustrative embodiments.

### DETAILED DESCRIPTION

### Example System Environment for Smart Cart System

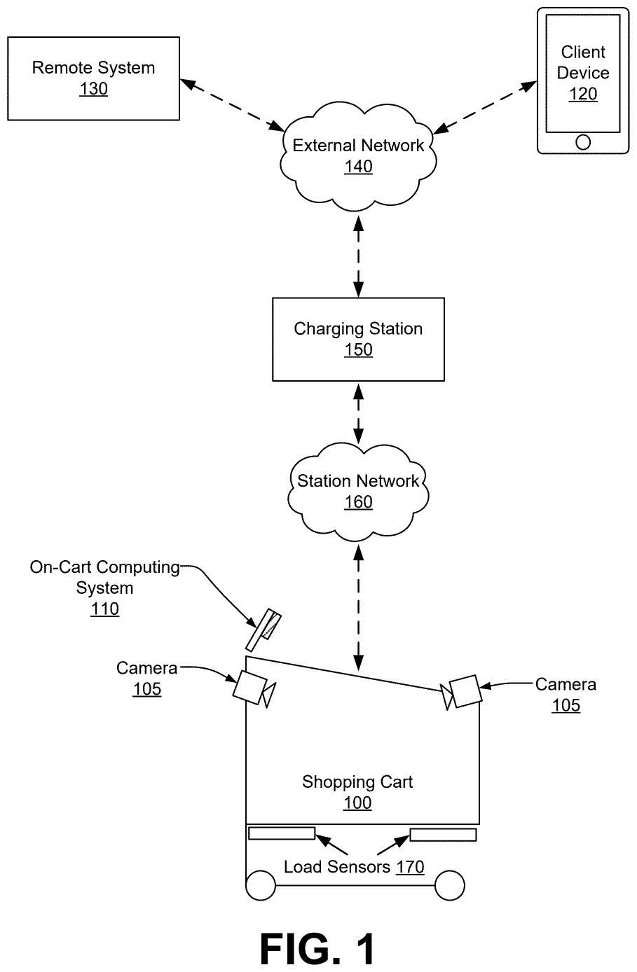

FIG. 1 illustrates an example system environment for a smart cart system, in accordance with one or more illustrative embodiments. The system environment illustrated in FIG. 1 includes a shopping cart 100, a client device 120, a remote system 130, a external network 140, a charging station 150, and a station network 160. Alternative embodiments may include more, fewer, or different components from those illustrated in FIG. 1, and the functionality of each component may be divided between the components differently from the description below. For example, functionality described below as being performed by the shopping cart may be performed, in some embodiments, by the remote system 130 or the client device 120. Similarly, functionality described below as being performed by the remote system 130 may, in some embodiments, be performed by the shopping cart 100 or the client device 120. Additionally, each component may perform their respective functionalities in response to a request from a human, or automatically without human intervention.

A shopping cart 100 is a vessel that a user can use to hold items as the user travels through a store. The shopping cart 100 includes one or more cameras 105 that capture image data of the shopping cart's storage area and a user interface that the user can use to interact with the shopping cart 100. The shopping cart 100 may include additional components not pictured in FIG. 1, such as processors, computer-readable media, power sources (e.g., batteries), network adapters, or sensors (e.g., load sensors, thermometers, proximity sensors).

The cameras 105 capture image data of the shopping cart's storage area. The cameras 105 may capture two-dimensional or three-dimensional images of the shopping cart's contents. The cameras 105 are coupled to the shopping cart 100 such that the cameras 105 capture image data of the storage area from different perspectives. Thus, items in the shopping cart 100 are less likely to be overlapping in all camera perspectives. In some embodiments, the cameras 105 include embedded processing capabilities to process image data captured by the cameras 105. For example, the cameras 105 may be mobile industry processor interface (MIPI) cameras. The cameras 105 may be set to capture images from the area surrounding the shopping cart including the user of the cart. In some embodiments, at least one of the cameras 105 is directed outward, away from the shopping cart 100.

In some embodiments, the shopping cart 100 captures image data in response to detecting that an item is being added to the storage area. The shopping cart 100 may detect that an item is being added to the storage area 115 of the shopping cart 100 based on sensor data from sensors on the shopping cart 100. For example, the shopping cart 100 may detect that a new item has been added when the shopping cart 100 (e.g., load sensors 170) detects a change in the overall weight of the contents of the storage area 115 based on load data from load sensors. Similarly, the shopping cart 100 may detect that a new item is being added based on proximity data from proximity sensors indicating that something is approaching the storage area of the shopping cart 100. The shopping cart 100 may capture image data within a timeframe near when the shopping cart 100 detects a new item. For example, the shopping cart 100 may activate the cameras 105 and store image data in response to detecting that an item is being added to the shopping cart 100 and for some period of time after that detection.

The shopping cart 100 may include one or more sensors that capture measurements describing the shopping cart 100, items in the shopping cart's storage area, or the area around the shopping cart 100. For example, the shopping cart 100 may include load sensors 170 that measure the weight of items placed in the shopping cart's storage area. Load sensors 170 are further described below. Similarly, the shopping cart 100 may include proximity sensors that capture measurements for detecting when an item is added to the shopping cart 100. The shopping cart 100 may transmit data from the one or more sensors to the remote system 130.

The one or more load sensors 170 capture load data for the shopping cart 100. In some embodiments, the one or more load sensors 170 may be scales that detect the weight (e.g., the load) of the content in the storage area 115 of the shopping cart 100. The load sensors 170 can also capture load curves—the load signal produced over time as an item is added to the cart or removed from the cart. The load sensors 170 may be attached to the shopping cart 100 in various locations to pick up different signals that may be related to items added at different positions of the storage area. For example, a shopping cart 100 may include a load sensor 170 at each of the four corners of the bottom of the storage area 115. In some embodiments, the load sensors 170 may record load data continuously while the shopping cart 100 is in use. In other embodiments, the shopping cart 100 may include some triggering mechanism, for example a light sensor, an accelerometer, or another sensor to determine that the user is about to add an item to the shopping cart 100 or about to remove an item from the shopping cart 100. The triggering mechanism causes the load sensors 170 to begin recording load data for some period of time, for example a preset time range.

The shopping cart 100 may include one or more wheel sensors (not shown) that measure wheel motion data of the one or more wheels. The wheel sensors may be coupled to one or more of the wheels on the shopping cart. In some embodiments, a shopping cart 100 includes at least two wheels (e.g., four wheels in the majority of shopping carts) with two wheel sensors coupled to two wheels. In further embodiments, the two wheels coupled to the wheel sensors can rotate about an axis parallel to the ground and can orient about an axis orthogonal or perpendicular to the ground. In other embodiments, each of the wheels on the shopping cart has a wheel sensor (e.g., four wheel sensors coupled to four wheels). The wheel motion data includes at least rotation of the one or more wheels (e.g., information specifying one or more attributes of the rotation of the one or more wheels). Rotation may be measured as a rotational position, rotational velocity, rotational acceleration, some other measure of rotation, or some combination thereof. Rotation for a wheel is generally measured along an axis parallel to the ground. The wheel rotation may further include orientation of the one or more wheels. Orientation may be measured as an angle along an axis orthogonal or perpendicular to the ground. For example, the wheels are at 0° when the shopping cart is moving straight and forward along an axis running through the front and the back of the shopping cart. Each wheel sensor may be a rotary encoder, a magnetometer with a magnet coupled to the wheel, an imaging device for capturing one or more features on the wheel, some other type of sensor capable of measuring wheel motion data, or some combination thereof.

The shopping cart 100 includes an on-cart computing system 110 that enables the user to perform an automated checkout through the shopping cart 100. The computing system includes a processor and a non-transitory computer-readable medium that stores instructions that may be executed by the processor. The computing system 110 also may include a display, a speaker, a microphone, a keypad, or a payment system (e.g., a credit card reader). The computing system 110 also includes a wireless network adapter that allows the computing system to communicate via the station network 160 or external network 140.

The on-cart computing system 110 allows a customer at a brick-and-mortar store to complete a checkout process in which items are scanned and paid for without having to go through a human cashier at a point-of-sale station. The on-cart computing system 110 receives data describing a user's shopping trip in a store and generates a shopping list based on items that the user has selected. For example, the on-cart computing system 110 may receive data from cameras or sensors coupled to the shopping cart 100 and may determine, based on the data, which items the user has added to their cart.

The on-cart computing system 110 may use machine-learning models or computer-vision techniques to identify items that the user adds to the shopping cart. For example, the on-cart computing system 110 may apply a barcode detection model to images captured by a camera of the shopping cart to identify items based on the barcodes that are visible to the camera. The barcode detection model is a machine-learning model (e.g., a neural network) that is trained to identify item identifiers that are encoded in barcodes that are depicted in image data. The barcode detection model may be trained based on a set of training examples. Each of the training examples may include an image of a barcode and a label that indicates what item identifier encoded by the barcode. In some embodiments, the on-cart computing system 110 preprocesses the image before applying the barcode detection model to the image. For example, the on-cart computing system may rotate the image so that the barcode is aligned with a set direction or may crop an image of an item to a portion of the image that depicts the barcode. U.S. patent application Ser. No. 17/703,076, entitled “Image-Based Barcode Decoding” and filed Mar. 24, 2022, describes an example barcode detection model in accordance with some embodiments and is incorporated by reference.

The on-cart computing system also may store and apply an optical character recognition (OCR) model to the image. An OCR model is a machine-learning model that converts typed, handwritten, or printed text depicted in images into machine-readable text. The on-cart computing system applies the OCR model to images captured by the cameras to identify items depicted in those images. For example, the on-cart computing system may generate a set of OCR text for an image. This OCR text is text that the OCR model has identified as being depicted in the image. The on-cart computing system uses the OCR text to identify items in images. For example, the on-cart computing system may apply another machine-learning model (e.g., a large language model) to the OCR text to predict which item is depicted in the image based on the OCR text.

In some embodiments, the on-cart computing system uses an item lookup table to identify items depicted in an image based on OCR text extracted from that image. The item lookup table stores a set of items that may be depicted in images captured by the cameras and corresponding text that is associated with each of the items. The on-cart computing system stores the item lookup table for use in identifying items. For example, the on-cart computing system may compare OCR text from an image to the corresponding text for each of the items to identify items depicted in images. The on-cart computing system may identify the item by identifying which item in the item lookup table has the most characters or words in common with the OCR text or which item has the longest sequence of characters in common with the OCR text. In some embodiments, rather than storing text in the item lookup table, the item lookup table stores embeddings that represent text associated with items. In these embodiments, the on-cart computing system may generate an embedding for OCR text and compare that embedding to the embeddings stored in the item lookup table to identify the item.

Furthermore, the on-cart computing system may store and apply an image embedding model to captured images to identify items. The image embedding model is a machine-learning model that is trained to generate embeddings for images captured by the cameras. The on-cart computing system applies the image embedding model to images captured by the cameras of the shopping cart and uses the embeddings to identify which items are depicted in the images. For example, the on-cart computing system may store embeddings that correspond to items that a user may place in the shopping cart. Each item may be associated with a single embedding or multiple embeddings. The on-cart computing system applies the image embedding model to images captured by the cameras and compares the generated embeddings to stored embeddings for items. The on-cart computing system identifies which item or items are depicted in an image based on how similar the generated embeddings are to the stored embeddings corresponding to the item(s). For example, the on-cart computing system may compute a distance, dot product, or cosine similarity between the embeddings to identify the item in the images. U.S. patent application Ser. No. 17/726,385, entitled “System for Item Recognition using Computer Vision” and filed Apr. 21, 2022, describes example methodologies for identifying items using a machine-learning model and is incorporated by reference.

Any of these models may be sensor fusion models that take sensor data as additional inputs. For example, a model may use weight data from a load sensor or proximity data from a proximity sensor as an additional input to predict an identifier for an item added to the shopping cart. For example, a shopping cart may use load sensor data and image data to identify items that are added to a shopping cart. A shopping cart includes multiple load sensors that measure the weight of its storage area. The shopping cart also includes cameras that capture image data of the storage area. When the shopping cart detects that an item has been added to the storage area, the shopping cart captures load data from the multiple load cells and image data from the cameras. The shopping cart then applies the trained machine-learning model to the load data and the image data to identify the item that is added to the cart based on the load data and the image data. The shopping cart adds the identified item to a shopping list for the user.

To train a model to identify items that are added to the shopping cart, the system accesses a set of labeled training examples. Each training example describes an item being added to a cart and includes load data describing load values imparted by an item over a series of timestamps as the item is added to the storage area of the shopping cart and image data describing image frames of portions of the storage area of the shopping cart captured over the series of timestamps as the item is added to the storage area of the shopping cart. The detection system applies the model to the training examples to produce an output value identifying the item that was added to the shopping cart. To generate a loss value, the system compares the predicted output value to the labels on the training data. The parameters of the model are updated based on the loss and the parameter values are stored for later use in identifying items in a shopping cart. U.S. patent application Ser. No. 17/874,956, entitled “Training a Model to Identify Items based on Image Data and Load Curve Data” and filed Jul. 27, 2022, describes an example sensor fusion model and is incorporated by reference.

The on-cart computing system 110 generates a shopping list for the user as the user adds items to the shopping cart 100. The shopping list is a list of items that the user has gathered in the storage area 115 of the shopping cart 100 and intends to purchase. The shopping list may include identifiers for the items that the user has gathered (e.g., stock keeping units (SKUs)) and a quantity for each item. When the user indicates that they are done shopping at the store, the on-cart computing system 110 interfaces with the remote system 130 to facilitate a transaction between the user and the store for the user to purchase their selected items. For example, the on-cart computing system 110 may receive payment information from the user through a user interface and transmit that payment information to the remote system 130.

The user interface of the on-cart computing system 110 may allow the user to adjust the items in their shopping list or to provide payment information for a checkout process. Additionally, the user interface may display a map of the store indicating where items are located within the store. In some embodiments, a user may interact with the user interface to search for items within the store, and the user interface may provide a real-time navigation interface for the user to travel from their current location to an item within the store. The user interface also may display additional content to a user, such as suggested recipes or items for purchase. In some embodiments, the on-cart computing system 110 may receive content from the remote system 130 to display to the user. For example, the on-cart computing system may receive item recommendations, recipe recommendations, or brand recommendations from the remote system 130.

The on-cart computing system may include a tracking system configured to track a position, an orientation, movement, or some combination thereof of the shopping cart 100 in an indoor environment. The tracking system may further include other sensors capable of capturing data useful for determining position, orientation, movement, or some combination thereof of the shopping cart. Other example sensors include, but are not limited to, an accelerometer, a gyroscope, etc. The tracking system may provide real-time location of the shopping cart to an online system and/or database. The location of the shopping cart may inform content to be displayed by the user interface. For example, if the shopping cart 100 is located in one aisle, the display can provide navigational instructions to a user to navigate them to a product in the aisle. In other example use cases, the display can provide suggested products or items located in the aisle based on the user's location.

A user can also interact with the shopping cart 100 or the remote system 130 through a client device 120. The client device 120 can be a personal or mobile computing device, such as a smartphone, a tablet, a laptop computer, or desktop computer. In some embodiments, the client device 120 executes a client application that uses an application programming interface (API) to communicate with the remote system 130 through the external network 140. The client device 120 may allow the user to add items to a shopping list and to checkout through the remote system 130. For example, the user may use the client device 120 to capture image data of items that the user is selecting for purchase, and the client device 120 may provide the image data to the remote system 130 to identify the items that the user is selecting. The client device 120 may adjust the user's shopping list based on the identified item. In some embodiments, the user can also manually adjust their shopping list through the client device 120.

In some embodiments, the on-cart computing system 110, the camera(s), and the sensors of the shopping cart are separately mounted to the shopping cart. Alternatively, the on-cart computing system 110, camera(s), and sensors may be contained within a single casing that is mounted to the shopping cart. This single casing may contain all of the components needed by the on-cart computing system 110 to perform the functionalities described herein. The single casing may be permanently mounted to the shopping cart or may be configured to be easily attached to or detached from the shopping cart. This latter embodiment may enable the on-cart computing system 110 to be recharged at a separate station from the shopping cart or may allow the computing system 110 to be easily mounted to pre-existing shopping carts, rather than requiring specially built shopping carts.

The shopping cart 100 and client device 120 can communicate with the remote system 130 via an external network 140. The external network 140 is a collection of computing devices that communicate via wired or wireless connections. The external network 140 may include one or more local area networks (LANs) or one or more wide area networks (WANs). The external network 140, as referred to herein, is an inclusive term that may refer to any or all of standard layers used to describe a physical or virtual network, such as the physical layer, the data link layer, the network layer, the transport layer, the session layer, the presentation layer, and the application layer. The external network 140 may include physical media for communicating data from one computing device to another computing device, such as MPLS lines, fiber optic cables, cellular connections (e.g., 3G, 4G, or 5G spectra), or satellites. The external network 140 also may use networking protocols, such as TCP/IP, HTTP, SSH, SMS, or FTP, to transmit data between computing devices. In some embodiments, the external network 140 may include Bluetooth or near-field communication (NFC) technologies or protocols for local communications between computing devices. The external network 140 may transmit encrypted or unencrypted data. In some embodiments, the station network 160 is connected to the external network 140 and the client device 120 or the remote system 130 communicate with the shopping cart 100 through the station network 160.

The external network 140 includes a local network at a store operating the smart shopping carts. The local network may be used by networked computing devices at the store, such as desktop or laptop computers. The charging station 150 is connected to the external network 140 through the local network.

The remote system 130 communicates with the on-cart computing system 110 of the shopping cart to provide an automated checkout experience for the user. The remote system 130 may facilitate the user's payment for the items in the shopping cart. For example, the remote system 130 may receive the user's shopping list from the shopping cart and charge the user for the cost of the items in the cart. The remote system 130 may communicate with other systems to execute the transaction, such as a computing system of the retailer or of a financial institution. The remote system 130 may receive payment information from the shopping cart 100 and uses that payment information to charge the user for the items. Alternatively, the remote system 130 may store payment information for the user in user data describing characteristics of the user. The remote system 130 may use the stored payment information as default payment information for the user and charge the user for the cost of the items based on that stored payment information.

The remote system 130 distributes software updates to shopping carts. For example, the remote system 130 may distribute software updates to charging stations 150 for distribution to respective smart carts via station networks 160. The distribution of software updates from a remote system 130 to shopping carts 100 is described in further detail below.

In some embodiments, the remote system 130 establishes a session for a user to associate the user's actions with the shopping cart 100 to that user. The user may establish the session by inputting a user identifier (e.g., phone number, email address, username, etc.) into a user interface of the remote system 130. The user also may establish the session through the client device 120. The user may use a client application operating on the client device 120 to associate the shopping cart 100 with the client device 120. The user may establish the session by inputting a cart identifier for the shopping cart 100 through the client application, e.g., by manually typing an identifier or by scanning a barcode or QR code on the shopping cart 100 using the client device 120. In some embodiments, the remote system 130 establishes a session between a user and a shopping cart 100 automatically based on sensor data from the shopping cart 100 or the client device 120. For example, the remote system 130 may determine that the client device 120 and the shopping cart 100 are in proximity to one another for an extended period of time, and thus may determine that the user associated with the client device 120 is using the shopping cart 100.

In some embodiments, a user who interacts with the shopping cart 100 or the client device 120 may be an individual shopping for themselves or a shopper for an online concierge system. The shopper is a user who collects items from a store on behalf of a user of the online concierge system. For example, a user may submit a list of items that they would like to purchase. The online concierge system may transmit that list to a shopping cart 100 or a client device 120 used by a shopper. The shopper may use the shopping cart 100 or the client device 120 to add items to the user's shopping list. When the shopper has gathered the items that the user has requested, the shopper may perform a checkout process through the shopping cart 100 or client device 120 to charge the user for the items. U.S. Pat. No. 11,195,222, entitled “Determining Recommended Items for a Shopping List,” issued Dec. 7, 2021, describes online concierge systems in more detail, which is incorporated by reference herein in its entirety.

A charging station 150 is a structure that recharges power sources, such as batteries, of shopping carts 100 at a source location. The charging station 150 includes a set of charging ports to which shopping carts 100 can be connected to be charged. Each port may include a charging cable that allows a user to easily connect the charging port from the charging station 150 to a port on the shopping cart 100. Similarly, the shopping carts 100 may include cables that can be coupled to charging ports on the charging station 150. In some embodiments, the on-cart computing system 110 can be disconnected from the shopping cart 100 and mounted on a charging port on the charging station 150.

In some embodiments, the shopping carts 100 may be charged by stacking the shopping carts into a dock of a charging station. The charging station 150 includes charging docks with dock connectors that connect with a charging connector of a shopping cart to provide electrical power to a stack of shopping carts. The first shopping cart 100 (i.e., the shopping cart that is directly connected to the docking station) may provide the electrical power from a dock connector of the docking station to power other shopping carts in the stack. In some embodiments, this electrical power is distributed to all of the shopping carts 100 in a stack. Alternatively, the electrical power may be primarily or entirely routed to the last shopping cart in the stack (i.e., the shopping cart 100 that does not have another shopping cart 100 stacked into it). Each shopping cart 100 in the stack may determine whether another shopping cart is connected to its rear charging connector, and if so, route electrical power that it receives to the shopping cart 100 that is stacked into it. If the shopping cart 100 does not detect that another shopping cart is stacked into it, the shopping cart 100 uses the electrical power to charge its battery. In some embodiments, the charging station 150 transmits a cart identifier to the shopping carts 100 in a stack and only the shopping cart that corresponds to the cart identifier is charged with electrical power received from the charging station 150. U.S. application Ser. No. 17/936,226, entitled “Stackable Charging Device for Shopping Carts with Onboard Computing Systems,” filed Sep. 28, 2022, is incorporated by reference herein in its entirety.

The charging station 150 includes a local computing system that provides computational functionality to support the charging station 150. The local computing system comprises a processing unit and a computer-readable medium to store and process data relevant to the shopping cart 100. The local computing system also may store software for selecting which shopping cart to update, prompting users to arrange or rearrange shopping carts within the charging station (e.g., using a process similar to the one described below), or to selectively deliver charging power to carts.

The local computing system of the charging station 150 also may store cart updates received from the remote system 130. A cart update is an update to software for the shopping cart 100. For example, a cart update may be a new version of an operating system, firmware, or applications executed on an on-cart computing system of a smart shopping cart. Such updates may also include security patches, new features, efficiency improvements, or new parameters for machine learning models operating on the carts. The local data store may also maintain cart update metadata, such as the version number of the cart update, the date when the cart update was distributed, and a measure of urgency or importance of the cart update.

The charging station 150 manages the distribution of cart updates to shopping carts 100. The update distribution module selects which shopping carts 100 to update with cart updates and distributes those cart updates to the shopping carts over the station network 160. The selection of shopping carts 100 for updating is described in further detail below.

Furthermore, the charging station 150 may stage cart data for transmission to the remote system 130 via the external network 140. The charging station 150 receives cart data from smart shopping carts 100 through the station network 160. For example, the charging station 150 may receive the cart data through the station network 160 as the smart shopping carts 100 collect the cart data, on a regular time interval, or whenever a smart shopping cart connects to the charging station 150 to charge. The charging station 150 may stage data for transmission by filtering out certain data that is not used by remote system 130 or by the charging station 150. For example, the charging station 150 may filter cart data that is within or outside of a particular time range. The charging station 150 may also stage data by identifying and flagging sets of data to be transmitted to the remote system 130. For example, the charging station 150 may have certain criteria for transmitting cart data to the remote system 130 and may only store and transmit cart data if the cart data meets those criteria. Further, the charging station 150 may remove sensitive information, such as personally identifiable information, from the received cart data. For example, the charging station 150 may remove a user's name, identifier, or payment information from the cart data before transmitting the cart data to the remote system 130. Similarly, if the cart data includes image or video data, the charging station 150 may remove or blur portions of the image data or video data that depicts a user's face.

In some embodiments, the charging station 150 extracts a set of features from the cart data for transmission to the remote system 130. The set of features may be features used by a machine-learning model operating on the remote system 130. The charging station 150 may extract features from types of cart data for which feature extraction significantly reduces the overall size of the transmitted data. For example, the charging station 150 may extract features from image or video data and transmit the features of the image data and video data to the remote system. In some embodiments, the charging station applies an embedding model to image data or video data to generate embeddings describing the data. The charging station 150 may transmit these embeddings to the remote system instead of or in addition to the image data or video data from which the embeddings were generated.

The station network 160 is a network over which the charging station 150 and shopping cart systems 100 are connected, either physically or wirelessly, through a series of wired or wireless connections. The station network 160 may include wireless networks, such as Wi-Fi or Bluetooth, and may also support wired connections, for example, through communication via charging ports. The station network 160 may be limited to the communication between the charging station 150 and the cart systems 100.

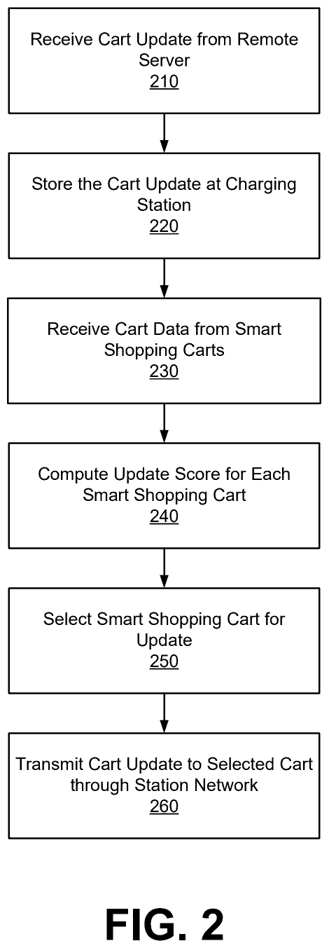

The charging station 150 uses the station network 160 to distribute cart updates to shopping carts. FIG. 2 illustrates a flowchart of a method for selecting a smart shopping cart for updating, in accordance with one or more illustrative embodiments. Alternative embodiments may include more, fewer, or different steps from those illustrated in FIG. 2, and the steps may be performed in a different order from that illustrated in FIG. 2. These steps may be performed by a charging station (e.g., charging station 150). Additionally, each of these steps may be performed automatically by the online system without human intervention.

The charging station receives 210 a cart update from a remote system and stores 220 the cart update on a local data store. The charging station receives the cart update from the remote system through an external network. For example, the charging station may be connected to a local network at the store and may receive the cart update through an external network via the local network.

The charging station uses cart data to select which smart shopping cart to prioritize for distribution of the cart update. The charging station collects the cart data by receiving 230 the cart data from the set of smart shopping carts through the station network. The charging station may receive the cart data regularly from the smart shopping carts (e.g., periodically). In some embodiments, the charging station receives cart data when a smart shopping cart connects to the charging station for charging. For example, the charging ports of the charging station may include data connections and the smart shopping carts may upload cart data to the charging station through the charging port when the smart shopping cart connects to the charging station to charge.

The charging station computes 240 an update score for each of the set of smart shopping carts based on the cart data. An update score is a score that indicates a priority of a smart shopping cart in being updated with a cart update. For example, a higher update score may indicate that a smart shopping cart is a higher priority for a cart update and a lower update score may indicate that a smart shopping cart is a lower priority for a cart update.

The charging station uses a set of cart selection parameters to compute the update score. The cart selection parameters are parameters for generating an update score. Cart selection parameters may include weights that correspond to values in cart data and the charging station may apply the weights to the values to compute the score. Similarly, the cart selection parameters may include heuristics or rules for generating a score for a smart shopping cart. For example, the cart selection parameters may include a rule that smart shopping carts cannot be updated within a certain timeframe (e.g., a timeframe during which use of the smart shopping carts is high). In some embodiments, the cart selection parameters include parameters for a machine-learning model that is trained to generate an update score for a smart shopping cart.

The charging station may use a variety of different cart data values to compute the update score for a smart shopping cart. The charging station may use the amount of energy remaining in the smart shopping cart's battery to compute the update score for the smart shopping cart. For example, the charging station may only update a smart shopping cart if the smart shopping cart has a threshold amount of energy left or may prioritize shopping carts with more energy left. Similarly, the charging station may use the time of day to compute update scores for smart shopping carts. For example, the charging station may prioritize updating smart shopping carts during times when smart shopping carts are less used.

In some embodiments, the charging station uses the smart shopping cart's position in a stack of charging smart shopping carts to compute the update score. The charging station may be configured such that smart shopping carts are stacked together while charging. U.S. application Ser. No. 17/936,226, entitled “Stackable Charging Device for Shopping Carts with Onboard Computing Systems” and incorporated by reference herein, describes example embodiments of a system for stackable charging of smart shopping carts. The charging station may compute update scores that prioritize updating smart shopping carts that are deeper in the stack of carts, meaning that those carts are less likely to be used by users. Thus, the update scores are computed to such that carts are less likely to be unavailable for use while being updated at a time when a user wants to use them.

The charging station selects 250 a smart shopping cart of the set of smart shopping carts to update based on the computed update scores. For example, the charging station may rank the smart shopping carts according to their update scores and select the top n carts with the highest scores for updating. Alternatively, the charging station may select carts with update scores that exceed a threshold value.

The charging station transmits 260 the cart update to selected smart shopping carts through the station network, which causes the smart shopping cart to update the software operating on the smart shopping cart. The charging station may transmit, with the cart update, instructions that cause the smart shopping cart to display a notification on its user interface that indicates that the smart shopping cart is unavailable for use. In some embodiments, the smart shopping cart displays an indication of another smart shopping cart for a user to use.

In some embodiments, the charging station prompts a user to arrange or rearrange smart shopping carts at the charging station such that the selected shopping cart is coupled to a particular charging port to be updated. For example, as noted above, the shopping carts may be stackable within a charging station and consequently certain shopping carts may remain at the top of the stacks of shopping carts that are coupled to the charging station. The charging station may eventually select one of the shopping carts that ends to be located towards the top of the stack, but the shopping cart would then be made unavailable for use by users until the update is complete. The charging station may prompt a user to move the selected shopping cart to another location within a stack or to a different stack of the charging station so that the selected shopping cart can charge while being updated. The charging station may prompt the user by displaying a notification on a screen of the shopping cart or by transmitting a notification to a client device associated with the user. In embodiments where the shopping carts are not stacked for charging, the charging station may prompt a user to arrange or rearrange shopping carts in different charging ports.

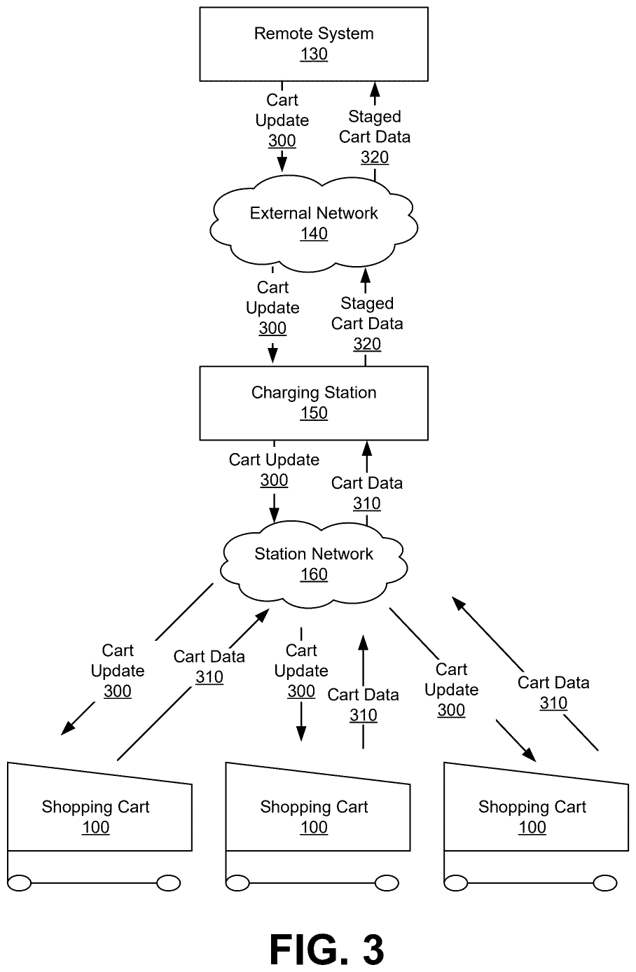

FIG. 3 illustrates the distribution of a cart update to smart shopping carts, in accordance with one or more illustrative embodiments. The remote system 130 transmits a cart update 300 to charging stations 150 through an external network 140. The charging stations 150 select which shopping carts 100 to update and distribute the cart updates 300 to their shopping carts 100 through the station network 160. Similarly, the cart data 310 from shopping carts 100 is transmitted to the charging station 150 via the station network 160. The charging station 150 stages cart data 310 and transmits the staged cart data 320 to the remote system 130 via the external network.

### Additional Considerations

The foregoing description of the embodiments has been presented for the purpose of illustration; it is not intended to be exhaustive or to limit the scope of the disclosure. Many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some embodiments, a software module is implemented with a computer program product comprising one or more computer-readable media containing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The weights may be stored on one or more computer-readable media, and are used by a system when applying the machine-learning model to new data.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C having at least one element in the combination that is true (or present). As a not-limiting example, the condition “A, B, or C” is satisfied by A and B are true (or present) and C is false (or not present). Similarly, as another not-limiting example, the condition “A, B, or C” is satisfied by A is true (or present) and B and C are false (or not present).

What is claimed is:

1. A method comprising:
receiving, at a charging station, a cart update from a remote computing system through a first network, wherein the cart update is an update to software operating on a set of smart shopping carts, and wherein the first network comprises the remote computing system and the charging station;
storing the cart update on a computer-readable medium of the charging station;
receiving cart data from the set of smart shopping carts through a second network, wherein the cart data is data describing the set of smart shopping carts, wherein the second network comprises the charging station and the set of smart shopping carts;
computing an update score for each of the set of smart shopping carts based on the cart data and a set of cart selection parameters, wherein the set of cart selection parameters comprises criteria for selecting which smart shopping cart to update;
selecting a smart shopping cart of the set of smart shopping carts to update based on the computed update scores; and
transmitting the cart update to selected smart shopping cart through the second network, wherein transmitting the cart update causes the smart shopping cart to update software operating on the smart shopping cart based on the cart update.

2. The method of claim 1, wherein the cart update comprises an update to one or more of: a client application, operating system, or firmware of the set of smart shopping carts.

3. The method of claim 1, wherein receiving cart data from a smart shopping cart is in response to the smart shopping cart coupling to a charging port of the charging station.

4. The method of claim 1, wherein the cart selection parameters comprises parameters for a machine-learning model that is trained to generate update scores for smart shopping carts based on cart data.

5. The method of claim 1, wherein selecting the smart shopping cart of the set of smart shopping carts comprises:
ranking the set of smart shopping carts based on the computed update scores.

6. The method of claim 1, wherein transmitting the cart update to the selected smart shopping cart comprises:
transmitting instructions to the selected smart shopping cart that cause the selected smart shopping cart to display a notification indicating that the smart shopping cart is unavailable.

7. The method of claim 1, wherein transmitting the cart update through the second network comprises:
transmitting the cart update through a charging port of the charging station.

8. The method of claim 1, wherein transmitting the cart update through the second network comprises:
transmitting the cart update through a wireless network.

9. The method of claim 1, further comprising:
transmitting the received cart data to the remote system through the first network.

10. The method of claim 9, wherein transmitting the received cart data to the remote system comprises:
filtering the cart data.

11. The method of claim 9, wherein the cart data comprises image data or video data and wherein transmitting the received cart data comprises:
applying an embedding model to the image data or the video data to generate an embedding; and
transmitting the embedding to the remote system through the first network.

12. A non-transitory computer-readable medium storing instructions that, when executed by a processor, cause the processor to perform operations comprising:
receiving, at a charging station, a cart update from a remote computing system through a first network, wherein the cart update is an update to software operating on a set of smart shopping carts, and wherein the first network comprises the remote computing system and the charging station;
storing the cart update on a computer-readable medium of the charging station;
receiving cart data from the set of smart shopping carts through a second network, wherein the cart data is data describing the set of smart shopping carts, wherein the second network comprises the charging station and the set of smart shopping carts;
computing an update score for each of the set of smart shopping carts based on the cart data and a set of cart selection parameters, wherein the set of cart selection parameters comprises criteria for selecting which smart shopping cart to update;
selecting a smart shopping cart of the set of smart shopping carts to update based on the computed update scores; and
transmitting the cart update to selected smart shopping cart through the second network, wherein transmitting the cart update causes the smart shopping cart to update software on the smart shopping cart based on the cart update.

13. The computer-readable medium of claim 12, wherein the cart update comprises an update to a client application, operating system, or firmware of the set of smart shopping carts.

14. The computer-readable medium of claim 12, wherein receiving cart data from a smart shopping cart is in response to the smart shopping cart coupling to a charging port of the charging station.

15. The computer-readable medium of claim 12, wherein the cart selection parameters comprises parameters for a machine-learning model that is trained to generate update scores for smart shopping carts based on cart data.

16. The computer-readable medium of claim 12, wherein selecting the smart shopping cart of the set of smart shopping carts comprises:
ranking the set of smart shopping carts based on the computed update scores.

17. The computer-readable medium of claim 12, wherein transmitting the cart update to the selected smart shopping cart comprises:
transmitting instructions to the selected smart shopping cart that cause the selected smart shopping cart to display a notification indicating that the smart shopping cart is unavailable.

18. The computer-readable medium of claim 12, wherein transmitting the cart update through the second network comprises:
transmitting the cart update through a charging port of the charging station.

19. The computer-readable medium of claim 12, wherein transmitting the cart update through the second network comprises:
transmitting the cart update through a wireless network.

20. A system comprising:
a processor; and
a non-transitory computer-readable medium storing instructions that, when executed by a processor, cause the processor to perform operations comprising:
receiving, at a charging station, a cart update from a remote computing system through a first network, wherein the cart update is an update to software operating on a set of smart shopping carts, and wherein the first network comprises the remote computing and the charging station;
storing the cart update on a computer-readable medium of the charging station;
receiving cart data from the set of smart shopping carts through a second network, wherein the cart data is data describing the set of smart shopping carts, wherein the second network comprises the charging station and the set of smart shopping carts;
computing an update score for each of the set of smart shopping carts based on the cart data and a set of cart selection parameters, wherein the set of cart selection parameters comprises criteria for selecting which smart shopping cart to update;
selecting a smart shopping cart of the set of smart shopping carts to update based on the computed update scores; and
transmitting the cart update to selected smart shopping cart through the second network, wherein transmitting the cart update causes the smart shopping cart to update software on the smart shopping cart based on the cart update.
